(19) United States
(12) Patent Application Publication
(10) Pub. No.: US 2007/0112869 A1
(43) Pub. Date: May 17, 2007

(54) System and method for managing data in a database

(75) Inventor: Kishore Gadiraju, Sunnyvale, CA (US)

Correspondence Address: William L. Botjer, PO Box 478, Center Moriches, NY, 11934, US

(73) Assignee: SOLIX, INC.

(21) Appl. No.: 11/274,558

(22) Filed: Nov. 15, 2005

(51) Int. Cl. G06F 17/30

(52) U.S. Cl. 707/200

(57) ABSTRACT

A method, system and computer program product for managing data in a database, such as a relational database is provided. A configuration engine is provided that includes a configuration-customizing module and a processing module. The processing module processes the data, based on a customized configuration built by the configuration-customizing module. The configuration is a relationship between a data set and at least one related data set from the database. The configuration-customizing module includes a configuration-defining module and a criteria-defining module. The configuration-defining module defines a configuration and the criteria-defining module defines criteria to be applied on the configuration. The processing module includes a selecting module and an operating module. The selecting module selects the data, based on the configuration and the criteria. The operating module processes the selected data.

### BACKGROUND

The present invention relates generally to databases. More specifically, the present invention relates to a system and a method for managing data in a relational database. The relational database may be associated with an online transaction processing system (OLTP).

In recent times, the data managed by entities has increased many times owing to the rapid growth of the Internet and e-business, the increase in online transaction processing and the expansion of large databases that support such applications. This rapid growth is driving increasing demand for data storage and data management solutions.

In addition, there is an increasing need to maintain easy access to historical information for business or regulatory requirements. For example, a company may need to protect its interests by retrieving historical financial transactions to satisfy customer inquiries and resolve claims. In other cases, corporate policy or government-mandated retention requirements dictate that data must remain accessible for years after it is collected.

Access to important data may be maintained by archiving the data. The archiving of the data allows storage of historical information, while improving the performance of the applications from where the data has been archived. The improvement may be in the form of processing speed or memory consumed.

In cases where selected data needs to be archived, individual solutions need to be developed on a case-to-case basis. Consequently, these solutions require dedicated development, and are usually time consuming and expensive. Further, the solutions do not allow simple access to the archived data, as the data may not be stored online.

### SUMMARY

An object of the invention is to manage data in a database.

Another object of the invention is to customize the process of managing data in the database.

Still another object of the invention is to archive data in a database associated with an application.

Yet another object of the invention is to purge the data from an application, once the data has been archived.

The present invention provides a method, system and computer program product for managing data in a database, such as a relational database. The relational database may be associated with an application such as an Online Transaction Processing (OLTP) system.

The configuration engine includes a configuration customizing module and a processing module. The processing module processes the data based on a customized configuration built by the configuration customizing module. The configuration is a relationship between a data set and at least one related data set.

The configuration customizing module includes a configuration defining module and a criteria defining module. The configuration defining module defines a configuration and the criteria defining module defines criteria for applying on the configuration.

The processing module includes a selecting module and an operating module. The selecting module selects the data based on the configuration and the criteria. The operating module processes the selected data.

According to the invention, a configuration is created. Further, at least one criterion is applied on the configuration. The at least one criterion enables identification of data that is to be archived. Thereafter, the selected data is processed.

The processing may include: archiving the data from the database to a second database, purging the data from the database and de-archiving the archived data.

The invention enables processing of the selected data to be customized according to individual requirements. This ensures that an exclusive archiving solution need not be created each time the archiving requirements are changed. A single software system provided by the invention provides a customized solution for every individual archiving requirement.

The configuration engine processes the data according to an algorithm that can be customized by defining at least one criterion that can be applied on the configuration. Further, the processing power of the applications improves through the process of archiving. Moreover, simultaneous access of both the existing data and the archived data is enabled as the archived data is accessible online.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram illustrating an environment where an exemplary embodiment of the invention may be implemented;

FIG. 2 is a block diagram illustrating various elements of a configuration engine, in accordance with various embodiments of the invention;

FIG. 3 is an exemplary block diagram of a graphical user interface (GUI) of a designer screen, in accordance with various embodiments of the invention;

FIG. 4 is an exemplary block diagram of a GUI of a criteria-definition screen, in accordance with various embodiments of the invention;

FIG. 5 is a block diagram illustrating various elements of an operating module, in accordance with various embodiments of the invention;

FIG. 6 is a block diagram illustrating various elements of a processing module, in accordance with various embodiments of the invention;

FIG. 7 is a block diagram illustrating various elements of a de-archiving module, in accordance with various embodiments of the invention;

FIG. 8 is an exemplary block diagram of a GUI of a de-archive screen, in accordance with various embodiments of the invention;

FIG. 9 is a flowchart illustrating a method for managing a plurality of databases, in accordance with various embodiments of the invention; and

FIG. 10 is a flowchart illustrating a method for defining a configuration, in accordance with various embodiments of the invention.

### DESCRIPTION OF PREFERRED EMBODIMENTS

Definitions:

Configuration: A configuration represents a relationship between at least one data set and at least one related data set in a database.

Criteria: A criteria includes a set of attributes to customize the selection of data represented by the configuration. At least one criterion is applied on the configuration to identify data from the at least one data set and at least one related dataset. The criteria may provide information including, for example, the type of data (character type, number type), the amount of data, and the format of data to be selected.

Selected Data: Data that is selected from a database by applying at least one criterion on the configuration.

Archived data: Selected data, archived from a database to a second database.

Client: The client is a software entity that interacts with the configuration engine and an associated server. The client may enable creating a configuration, changing the criteria on an existing configuration, processing the selected data and the like.

The present invention relates to applications associated with a relational database. More specifically, the present invention relates to a method, system, and computer program product for managing data in a database.

Various embodiments of the invention provide a method, system, and computer program product for processing data in a database. The database may be a part of an online transaction-processing system (OLTP). The OLTP is a system used for processing transactions and providing information, to complete a transaction. The processing may include archiving the data in a second database, de-archiving the data, and/or purging the data from the database.

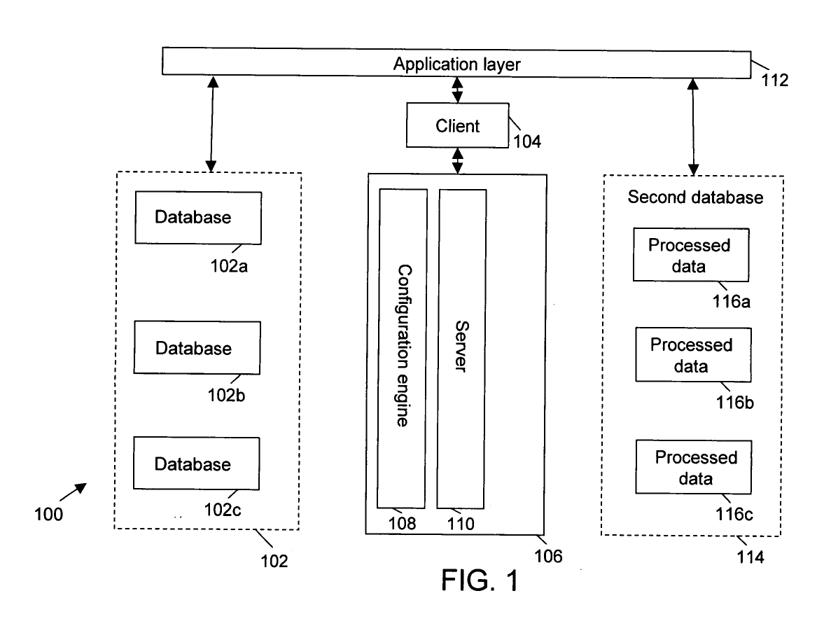

FIG. 1 is a block diagram illustrating an environment 100, where an exemplary embodiment of the invention may be implemented. Environment 100 includes databases 102, including a database 102a; a database 102b and a database 102c; a client 104, a system 106, including a configuration engine 108, and a server 110, an application layer 112; a second database 114 that stores a plurality of processed data 116, including a processed data 116a; a processed data 116b, and a processed data 116c.

In various embodiments of the invention, databases 102 are relational databases. Further, each of databases 102 may be associated with an application such as an online transaction-processing (OLTP) system. The OLTP system facilitates and manages applications involving transactions. Examples of OLTP systems include, but are not limited to, electronic banking, order processing, e-commerce, manufacturing processing, airlines, and mail orders. OLTP systems work with Enterprise Resource Planning systems such as Oracle, People Soft, SAP, and the like. The aforementioned ERP systems integrate information related to departments and functions across an organization into a single database, such as, for example database 102a. ERP systems comprise function-specific modules designed to interact with the other modules such as Accounts Receivable, Accounts Payable, Purchasing and the like.

Client 104 interacts with system 106 and application layer 112. Also, databases 102 interact with application layer 112. For example, consider an OLTP system used by an airline booking system. In this case, client 104 is capable of conducting a transaction such as making an online request to book a ticket on behalf of a customer through application layer 112. Thereafter, information stored in the databases 102 may also be correspondingly altered. Further, client 104 may also have the functionality to process data stored in system 106. Processed data 116 is stored in second database 114.

With respect to system 106, configuration engine 108 is connected to server 110. Configuration engine 108 enables the selection of the data stored in databases 102, and processes the data based on information provided by client 104. Server 110 enables the operation of configuration engine 108 by handling requests for data and other network resources from client 104. Moreover, server 110 stores the data selected from databases 102 and provide data-processing functionalities to client 104.

Application layer 112 is an interoperable layer that provides an interface for databases 102, second database 114 and system 106 to interact through client 104. Application layer 112 provides client 104 with the functionality of simultaneously viewing the data in databases 102 and processed data 116 in second database 114. Application layer 112 has been described in a co-owned U.S. patent application Ser. No. 10/800,376 filed Mar. 12, 2004, titled ‘System and Method for Seamless Access to Multiple Data Sources’ the disclosure of which is hereby incorporated by reference.

In various embodiments of the invention, each processed data 116 corresponds to each of databases 102. In an embodiment of the invention, processed data 116a corresponds to the data extracted from database 102a. For example, if database 102a stores production data before a two-year period, processed data 116b would store the corresponding archived production data in the form of data sets.

In an embodiment of the invention, second database 114 may be a part of databases 102. In another embodiment of the invention, second database 114 is an independent database from databases 102, and may be stored on an independent location (such as an independent hard drive).

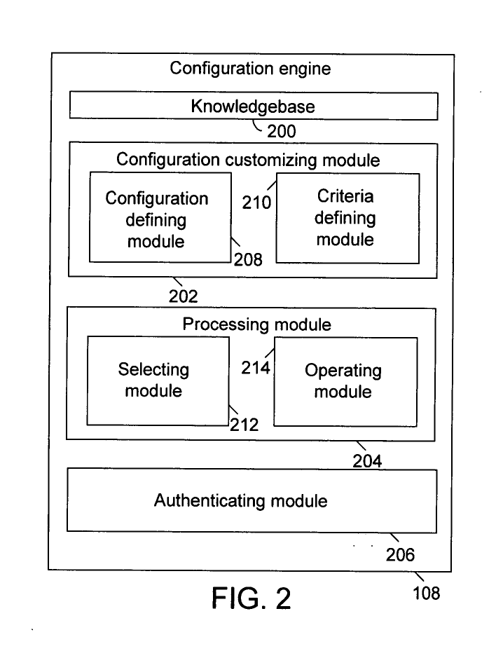

FIG. 2 is a block diagram illustrating various elements of configuration engine 108, in accordance with various embodiments of the invention. Configuration engine 108 includes a knowledgebase 200, a configuration-customizing module 202, a processing module 204, and an authenticating module 206.

Configuration-customizing module 202 selects data from a repository such as knowledgebase 200 and builds a customized configuration. In an exemplary embodiment, knowledgebase 200 may be located in server 110.

The names of the datasets which are used in processing are stored with knowledgebase 200. Further, knowledgebase 200 stores information about the relationship between the datasets. For example, knowledgebase 200 may include the names and relationship of the datasets in each of databases 102. It may be noted that the customized configuration may be built only from the datasets registered with knowledgebase 200.

In an embodiment of the invention, the data for building the customized configuration may be selected from databases 102. This customized configuration is used by processing module 204 to process the selected data. The kind of processing that needs to be carried out on selected data by client 104 depends on the profile of client 104. The profile of client 104 refers to various attributes of client 104, according to which functionalities of different kinds are assigned to client 104. For example, the profile of client 104 may be that of an administrator, a designer, a user, a reporter, or any other customizable client profile. The profile of client 104 is validated by authenticating module 206, to prevent unauthorized access to configuration engine 108.

Configuration-customizing module 202 customizes a configuration based on criteria defined by client 104. The configuration represents a relationship between a data set and at least one related data set. In an embodiment, the data set is a tabular structure. The data set includes a plurality of data parts, wherein each part is a column. In another embodiment, a data part may also be a row.

Configuration-customizing module 202 includes a configuration-defining module 208 and a criteria-defining module 210. Configuration-defining module 208 defines the configuration, which may be defined by selecting a number of tables from knowledgebase 200 and linking them together in a logical relationship. A driving table and at least one table related to the driving table are selected. The driving table is a table that includes data that is not dependent on any other table. A table related to the driving table may be referred to as a ‘child’ table. A driving table may, for instance, contain bibliographic details pertaining to an employee in an organization, whereas a related child table may contain financial information relating to the employee. Further, entries in a row, pertaining to the driving table are uniquely identified by a primary key; entries in a row, pertaining to the related child table, are identified by foreign keys. A foreign key in a child table refers to various attributes related to the entries associated with the primary key. The selection of entries in a driving table, by the use of criteria, enables the selection of corresponding entries in child tables by means of the foreign keys. Further, a plurality of configurations may be linked or arranged together by means of configuration-defining module 208, to form a configuration group. The configuration group allows additional data to be selected at an instance.

Criteria-defining module 210 defines a criterion to be applied on the configuration. A criterion may specify, for example, that data for every quarter before the end of a particular fiscal year, which is composed of four quarters is archived and/or purged. Another example may be to archive the data related to employees that have left an organization in the last three years. In another example, all information related to a client no longer associated with an organization may be archived for future reference. Therefore, defining the criteria on the configuration enables client 104 to customize the configuration.

Processing module 204 processes the data, based on the customized configuration. In various embodiments of the invention, processing module 204 interacts with databases 102 to process the selected data based on the customized configuration. In an embodiment of the invention, processing module 204 processes the selected data stored in knowledgebase 200. Processing module 204 includes a selecting module 212 and an operating module 214. Selecting module 212 selects the data, hereinafter referred to as selected data, based on the configuration and the criteria. In an exemplary embodiment, the selected data includes data in the selected columns of the driving table and the data in the corresponding columns of the related child tables. Operating module 214 processes the selected data.

For example, consider a driving table in an employee database that contains information pertaining to 100 employees, for example, information such as an employee's ID, which is used as a primary key (each employee has a unique employee ID) to access the employee's name, address, contact number, the department in which he/she is working, and his/her gross salary details. The related child table would include the employee's ID as a foreign key and the break up of the salary details as associated information pertaining to the employee. If the organization wants to archive only such information as the names, addresses and contact numbers of 20 employees, this information is selected from the driving table. Thereafter, selecting module 212 enables all the corresponding information relating to the 20 employees to be selected from the related child table. The selected data may then be processed.

Authenticating module 206 validates client 104 on the basis of the client's profile. In various embodiments of the invention, authenticating module 206 validates client 104 for providing access to system 106. In an embodiment of the invention, authenticating module 206 validates client 104 for providing access to configuration engine 108. Based on the validation, appropriate functionalities are assigned to client 104. Examples of profiles of client 104 may include, but are not limited to, an administrator, a designer, a user, a reporter, and the like. The role of the administrator may be to perform all administrative activities, for example, adding new users, changing passwords to access configuration engine 108, modify client profiles, and so forth. In an embodiment of the invention, the administrator performs any of the functionalities assigned to client 104. For example, the administrator may perform the functionalities of the designer. The role of the designer is to build new configurations and modify existing configurations. For example, the designer may modify the configuration by adding the related child tables to the existing driving table and/or associating a different criterion with the configuration. The designer may also be given permission to schedule the processing of the selected data. The role of the user is to use the configurations made by the designer. The role of the reporter is to receive reports pertaining to the processing of the data. Processing of the data, in the example given above, is carried out by configuration engine 108 and may be accessed by a reporter.

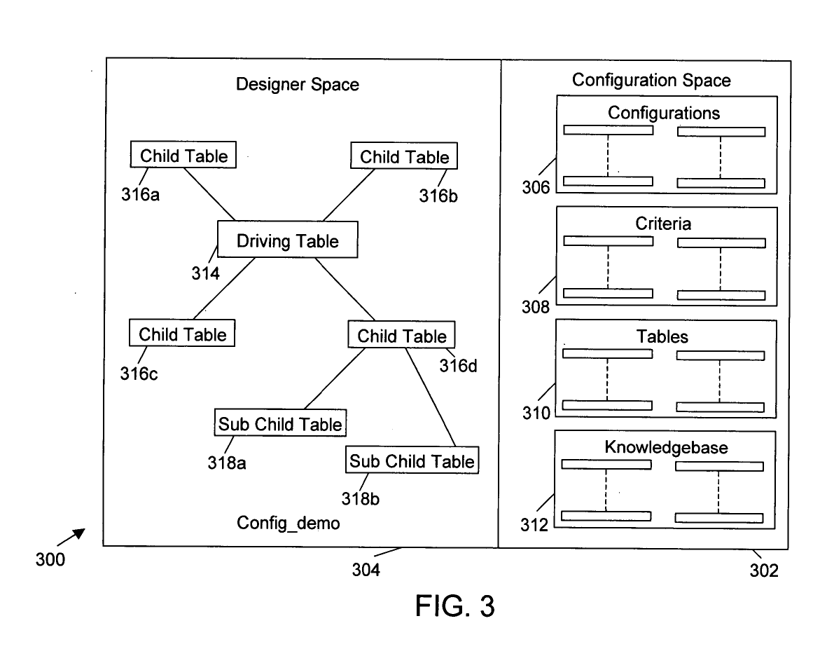

FIG. 3 is an exemplary block diagram of a designer screen 300, in accordance with various embodiments of the invention. Designer screen 300 illustrates a Graphical User Interface (GUI) that includes a configuration space 302 and a designer space 304. Configuration space 302 includes a configurations menu 306, a criteria menu 308, a tables menu 310, and a knowledgebase menu 312.

Designer space 304 enables the building the configuration using criteria menu 308 and knowledgebase menu 312. The configuration may be created by identifying a data set and linking the data set to at least one related data set.

The built configurations may subsequently be displayed in configurations menu 306. Tables menu 310 lists the tables corresponding to the configuration selected in configuration menu 306. Designer space 304 displays the configuration selected in configurations menu 306.

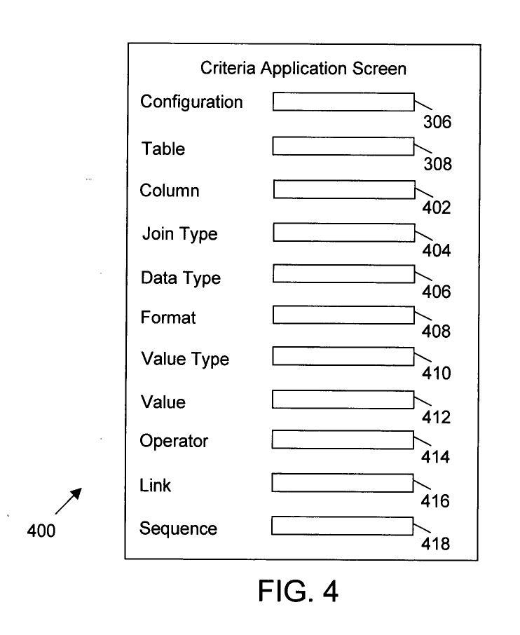

In an embodiment, the tables that are stored in databases 102 are registered in configuration engine 108. Registering implies that only a pre-defined number of tables from the entire set of tables available in databases 102 are available in knowledgebase menu 312 for the formation of the configuration. The registered set of tables is also referred to as a knowledgebase. In accordance with another embodiment, knowledgebase tables menu 312 includes all the tables stored in databases 102. Criteria menu 308 includes the criteria to be applied on the configuration. The exemplary criterion and the process of entering criteria into configuration engine 108 are explained with reference to FIG. 4.

The implementation of the designer screen 300 is explained herein: An example of a configuration, ‘config_demo’, is displayed in designer space 304. Configuration ‘config_demo’ includes a driving table 314; a plurality of child tables 316, including child tables 316, 316b, 316c and 316d; and a plurality of sub child tables 318, including sub-child tables 318a and 318b.

In an embodiment of the invention, driving table 314, child tables 316, and sub-child tables 318 are selected by using a ‘drag and drop’ functionality provided in designer screen 300. The drag and drop functionality enables the selection of a table such as, for example, driving table 314 from knowledgebase menu 312, dragging it from configuration menu 306 to designer space 304, and dropping it in designer space 304. Once driving table 314 has been selected corresponding child and sub-child tables are also selected by using the drag and drop functionality. For example, configuration config_demo is built by selecting driving table 314, child tables 316, and sub-child tables 318 from tables menu 310.

FIG. 4 is an exemplary block diagram of a criteria application screen 400, in accordance with various embodiments of the invention. Criteria application screen 400 includes configuration menu 306, table menu 310, a column menu 402, a join-type menu 404, a data-type menu 406, a format menu 408, a value-type menu 410, a value menu 412, an operator menu 414, a link menu 416, and a sequence menu 418.

The configuration for which the criterion is defined is selected from configuration menu 306. Thereafter, the tables corresponding to the selected configuration appear in table menu 310. At least one table may then be selected from table menu 310. Corresponding to the table selected, a list of columns appears in column menu 402. Subsequently, a column, hereinafter referred to as a selected column, is selected.

Various attributes of a selected column may be further specified. The attributes include for, example, the format of the data, the value type of the data, and the values included in the selected column. The manner in which the attributes are implemented on the selected column is specified by selecting the type of joining by choosing the options available in join-type menu 404. The options include the commonly used Boolean operators, including ‘and’, ‘not’, and ‘or’. Further, if there are multiple data types in the selected column, a particular data type may be specified by using the options available on the data type menu 406. The data types include, for example, a number type or a character type. Further, the criterion in the selected column can be further refined by specifying the format of the data in format menu 408. For example, a date (number type) in the selected column may be entered in the month/date/year format or in a date/month/year format. Alternatively, if the type of data is like a character, then the format may be specified accordingly. For instance, if a name is entered as the last name followed by the first name, the order may be reversed.

Moreover, the data in the selected column may take a constant value or a SQL value. This is specified in value type menu 410. An array of data in the selected column is selected by specifying operators in operator menu 414. For example, operators such as ‘less than’, ‘more than’, and ‘equal to’, etc., may be specified. In an embodiment of the invention, all the data that is equal to the value specified in value menu 412 in the column is selected on the selection of the ‘equal to’ operator in operator menu 414. Further, if the data takes the SQL value, the SQL value may be selected at run time. In an embodiment of the invention, the SQL value may be a dynamic value.

In various embodiments of the invention, if data other then the data value specified in value menu 412 in the column is to be selected, then ‘NOT’ is selected in join-type menu 404. The operator ‘equal to’ is selected in operator menu 414. The criteria enable selection of all the values in the column that are not equal to the value specified in value menu 412. Further, if only values equal to the value in value menu 412 are required, and ‘AND’ join type is selected in join type menu 404.

The criterion is applied on the configuration once all the parameters required to define the criteria are entered. In an embodiment of the invention, a plurality of criteria may be applied simultaneously by combining the criteria with previously defined criterion. A set of criteria may be applied on the configuration by linking one criterion with at least a second criterion. In an embodiment, this functionality is achieved by using link menu 416. Furthermore, the set of criteria can be placed in a predefined sequence by defining the sequence in sequence menu 418. In various embodiments of the invention, the criterion may be saved in configuration engine 108 by specifying the name of the criterion in criteria application screen 400.

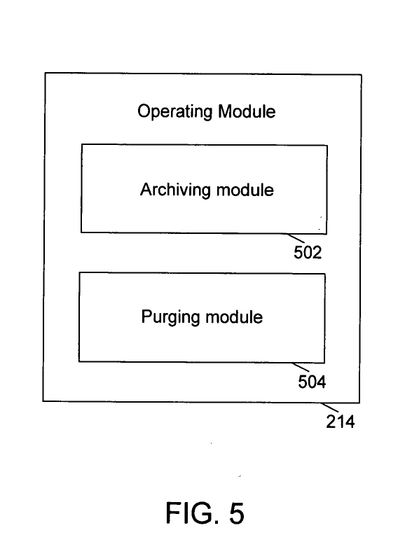

FIG. 5 is a block diagram illustrating various elements of operating module 214, in accordance with various embodiments of the invention. Operating module 214 includes an archiving module 502 and a purging module 504. Archiving module 502 archives the selected data to second database 114. In an embodiment of the invention, the archived data is not available in database 102. It may be noted that each time archiving is carried out an identification number, such as, for example, a ‘run-id’ is generated that serves to uniquely identify the instance of archiving the selected data. In an embodiment, second database 114 is an independent database. In another embodiment, second database 114 forms a part of databases 102.

In an embodiment, the archived data may be purged from databases 102 by purging module 504. This purging may be carried out after the selected data is archived. In another embodiment, the selected data is purged without archiving.

In accordance with various embodiments of the invention, the archiving is performed by using either of two methods: ‘bulk wise’ archiving or ‘transaction wise’ archiving. In the bulk wise archiving method, a plurality of records from a configuration, such as ‘config_demo’ is archived at an instance. In the transaction-wise archiving method, a single record is archived at an instance. It may be noted that the bulk wise archiving method takes less time to archive the selected data, compared to the transaction-wise archiving method. It may be apparent to a person skilled in the art that, the transaction-wise archiving process allows greater control over the process of archiving the selected data, as the archiving may be halted and reviewed after each instance.

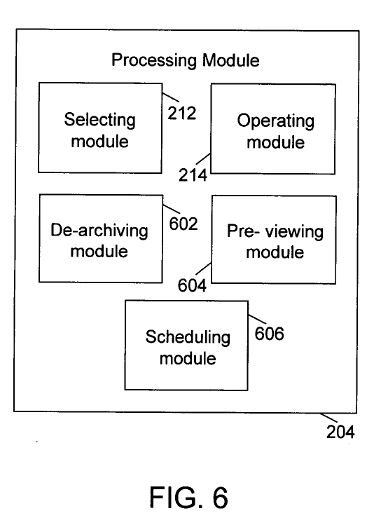

FIG. 6 is a block diagram illustrating various elements of processing module 204, in accordance with an embodiment of the invention. In addition to selecting module 212 and operating module 214, processing module 204 includes a de-archiving module 602, a pre-viewing module 604, and a scheduling module 606.

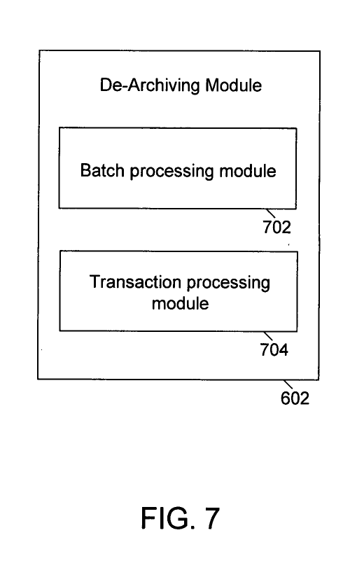

De-archiving module 602 de-archives the archived data from second database 114 and enables access to the archived data which data is subsequently brought back to databases 102. The functionalities of the de-archiving module are explained in detail with reference to FIG. 7.

Pre-viewing module 604 provides the status of the processing, such as archiving of the selected data, purging of the selected data, or de-archiving of the archived data. In an embodiment, the reporting of data is viewed in real time. Further, the reporting is viewed in the computer language in which either the archiving or de-archiving is carried out, such as, for example, SQL or C++. Pre-viewing module 604 also provides the status of databases 102 before and after the various processes, such as archiving, de-archiving or purging.

Scheduling module 606 schedules the working of selecting module 212 and operating module 214. In an embodiment, the processing of the selected data is scheduled by scheduling module 606. In accordance with an alternate embodiment, processing module 204 schedules the processing of the selected data according to a pre-defined policy. The pre-defined policy may be defined on the basis of the requirements of client 104. For example, consider a case where client 104 represents a company that defines the following policy: to store only two years' worth of (eight quarters of a financial year) production data for analysis. The scheduling may be carried out so that any production data appearing after the last eight quarters is selected and archived.

For a configuration that needs to be scheduled, details such as the time and date may be specified. A corresponding schedule ID is generated for each instance of scheduling, which may be used for verification.

FIG. 7 is a block diagram illustrating the elements of de-archiving module 602, in accordance with various embodiments of the invention. De-archiving module 602 includes a batch-processing module 702, and a transaction-processing module 704.

Batch-processing module 702 de-archives a batch or a plurality of records from the archived data at an instance. A batch is a collection of records that is treated as one entity at the time the archived data is de-archived. A record relates to a single entry in a table, such as a driving table or a related child table.

Transaction-processing module 704 performs a transaction-wise de-archiving, wherein a transaction or single record is de-archived from the archived data at an instance. It may be noted that in the case of transaction-wise archiving, a run-ID is selected in addition to the driving table, the configuration and the knowledgebase.

However, in the case of batch de-archiving only the run-id, the configuration and the knowledgebase needs to be selected.

It may be noted that the batch-wise de-archiving method takes less time to archive the selected data, as compared to the transaction-wise de-archiving method. It may be apparent to a person skilled in the art that the transaction-wise de-archiving process allows greater control over the process of de-archiving the archived data, as de-archiving may be stopped temporarily and reviewed after each instance.

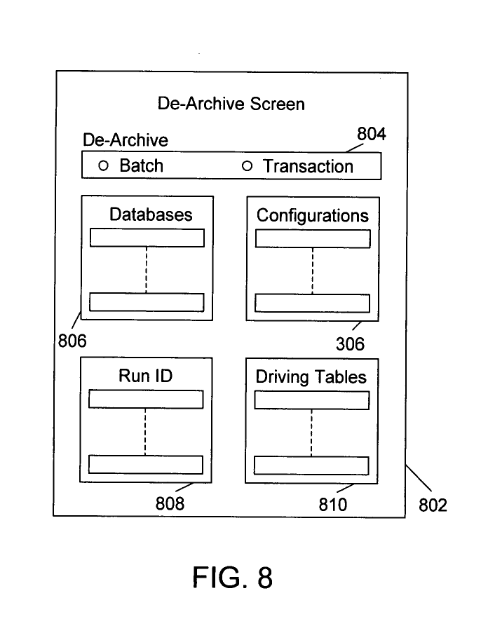

FIG. 8 is an exemplary block diagram of a GUI of a de-archive screen 802, in accordance with various embodiments of the invention. De-archive screen 802 includes a de-archive menu 804, a databases menu 806, a configurations menu 306, a run ID menu 808, and a driving tables menu 810.

In an embodiment, each of de-archive type menu 804, database menu 806, configurations menu 306, ‘run-id’ menu 808, and driving tables menu 810 is in the form of a standard drop-down menu, wherein an option can be selected amongst a plurality of options.

De-archive menu 804 provides the option of selecting the type of de-archiving to be performed, i.e., transaction-wise de-archiving or batch-wise de-archiving. Databases menu 806 includes databases 102 registered with configuration engine 108. On the selection of a database from databases 102, configurations menu 306 provides the configurations corresponding to the selected database. Run-ID menu 808 includes a list of the run-IDs corresponding to each instance of archived data. Driving tables menu 810 provides the list of driving tables corresponding to the run-ID selected from run-ID menu 808.

It may be noted that a driving table may be selected only in the case of transaction-wise de-archiving. The records that need to be de-archived are further identified by specifying the primary key. For example, consider a case where records of 100 employees in an organization are archived. In order to identify records of two employees to be de-archived, the respective primary keys associated with the two employees in the driving table need to be specified for de-archiving.

In an embodiment of the invention, de-archiving may be scheduled according to the pre-defined policy described with reference to FIG. 6.

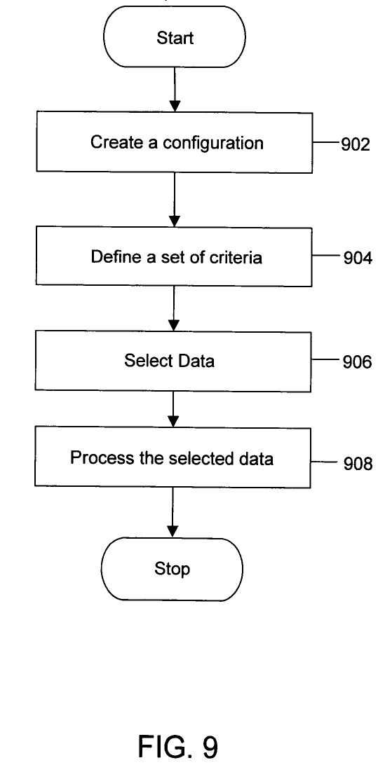

FIG. 9 is a flowchart illustrating a method for managing databases 102, in accordance with various embodiments of the invention. At step 902, a configuration, described with reference to FIG. 3, is created. In an embodiment of the invention, the configuration is defined from a knowledgebase comprising a predefined number of datasets selected from at least one database. At step 904, a set of criteria is defined, to be applied on the configuration. The set of criteria may be defined by a client such as client 104 with the profile of a designer. The different types of criteria and the process of entering the data are explained with reference to FIG. 4. At step 906, the data is selected by using the configuration and the applied criteria. At step 908, the selected data is processed. The processing includes archiving the selected data to a second database such as second database 114, or purging the selected data from databases such as databases 102.

It may be noted that a configuration may only be a single data set, such as for example a driving table. In another embodiment, the configuration includes the driving table linked with all predefined related tables. Further, as described with reference to FIG. 2, configurations may be linked or arranged together to form a configuration group. The configuration group allows additional data to be selected at an instance.

Further, the archived data may be brought back to the database such as databases 102, by de-archiving the archived data from the second database such as second database 114. Moreover, the processing of selected data can be scheduled according to a pre-defined policy, as described with reference to FIG. 6. This implies that the pre-defined policy allows the archiving or purging to take place according to a set of rules that are pre-defined.

In yet another embodiment of the invention, the selected data may be archived, based on a pre-defined policy.

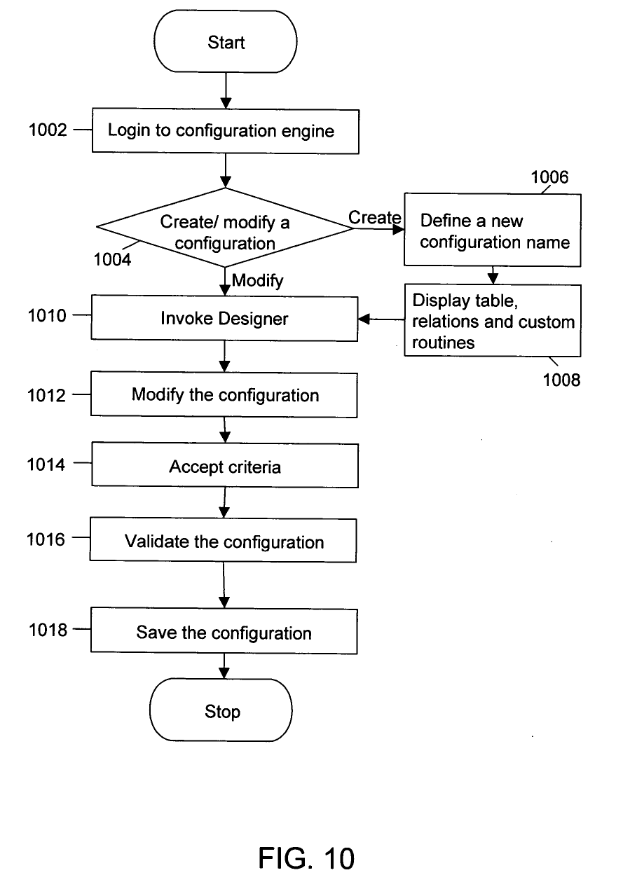

FIG. 10 is a flowchart illustrating a method for defining a configuration, in accordance with various embodiments of the invention. At step 1002, a client such as client 104 is logged onto a configuration engine, such as configuration engine 108. The client may be exemplified as a software entity that interacts with configuration engine 108 and an associated server, such as server 110. The client may enable functions such as creating a configuration, changing the criteria on an existing configuration, processing the selected data and the like.

The client is assigned one of the profiles (administrator, designer, user, and client) once logged onto the configuration engine. At step 1004, the client is provided the option of either creating a new configuration or modifying an existing one. This step is dependent on the profile of the client. For example, if the profile of the client is of a designer, the client has the permission to create as well as modify the configuration, whereas if the profile is that of a user, the client may have permission only to modify the configuration. At step 1006, if the client has the permission to create a new configuration, the client defines the new configuration. At step 1008, various tables, relations and custom routines are displayed. In an embodiment of the invention, relations between the tables may be stored in the knowledgebase. Also, all the custom routines that are created in databases and/or configuration engine are displayed in the knowledgebase.

At step 1010, a designer screen such as designer screen 300 is invoked if the client has permission to create a new configuration. Further, the flowchart is redirected to step 1010 after step 1004 if the client has permission to modify step 1010.

At step 1012, the configuration is modified depending on the profile of the client. At step 1014, the criteria applied for processing the selected data is accepted by the configuration engine. At step 1016, the configuration is validated to check whether the structure and content are suitable for processing. Exemplary details that are checked for validation include the size of the configuration, its structure and so forth. At step 1018, the configuration is saved in a configuration menu such as configuration menu 306, to enable the client to have access to it and process it.

In accordance with various embodiments of the invention, the configuration engine processes data according to the specific requirements of clients by generating a customized code based on a defined set of criteria.

In accordance with various embodiments of the invention, archiving data from a dynamic application such as an OLTP improves its performance, since it frees memory in a database, used in conjunction with the OLTP.

Further, various embodiments of the invention provide online access to the archived data through an application layer, which may be used in conjunction with the configuration engine.

In various embodiments of the invention, the various system modules described in the current invention, are implemented in software modules that is run on a system in configuration engine 108. The invention may be implemented in conjunction with standard ERP systems provided by vendors such as Oracle, PeopleSoft and JD Edwards.

The system in the configuration engine may be embodied in the form of a computer system. Typical examples of a system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device that enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A configuration engine for managing at least one database, the at least one database comprising a plurality of data sets, each data set comprising a plurality of data parts, at least one of the plurality of data sets being related to at least one of the plurality of the other data sets, the configuration engine comprising:
a. a configuration customizing module comprising:
i. a configuration defining module to define at least one configuration, the at least one configuration representing a relationship between at least one data set and at least one related data set; and
ii. a criteria defining module to define at least one criterion, the at least one criterion being applied on the at least one configuration to identify data from the at least one data set and the at least one related dataset; and
b. a processing module comprising:
i. a selecting module to select data based on the at least one configuration and the criteria; and
ii. an operating module to process the selected data.

2. The system according to claim 1, wherein the at least one configuration is defined from a knowledgebase comprising a predefined number of datasets selected from the at least one database.

3. The system according to claim 1, wherein the database is part of an online transaction processing system.

4. The system according to claim 1, wherein the selecting module enables selection of at least one corresponding data part of the at least one related data set upon selection of a data part in the data set.

5. The system according to claim 1, further comprising an authenticating module to identify and validate a user.

6. The system according to claim 1, wherein the operating module further comprises an archiving module to archive the selected data in a second database.

7. The system according to claim 6, wherein the processing module further comprises a de-archiving module to de-archive the archived data from the second database.

8. The system according to claim 7, wherein each of the plurality of data sets is a table comprising a plurality of records.

9. The system according to claim 8, wherein the de-archiving module comprises:
a. a batch processing module, the batch processing module de-archiving a plurality of records from the archived data at an instance; and
b. a transaction processing module, the transaction processing module de-archiving a record from the archived data at an instance

10. The system according to claim 6, wherein the second database is part of the database.

11. The system according to claim 1, wherein the operating module further comprises a purging module to purge the selected data in the database.

12. The system according to claim 1, wherein the operating module further comprises a pre-viewing module to provide the status of the processing of the selected data.

13. The system according to claim 1, wherein the operating module further comprises a scheduling module to schedule the processing of the selected data.

14. The system according to claim 1, wherein each of the plurality of data parts is a column of the table.

15. A configuration engine for managing at least one database, the at least one database comprising a plurality of data sets, each data set comprising a plurality of data parts, at least one of the plurality of data sets being related to at least one of the plurality of the other data sets, the configuration engine comprising:
a. a knowledgebase comprising a predefined number of datasets selected from the at least one database;
b. a configuration customizing module comprising:
i. a configuration defining module to define at least one configuration, the at least one configuration representing a relationship between at least one data set and at least one related data set selected from the knowledgebase; and
ii. a criteria defining module to define at least one criterion, the at least one criterion being applied on the at least one configuration to identify data from the at least one data set and the at least one related dataset; and
c. a processing module comprising:
i. a selecting module to select data from the knowledgebase based on the at least one configuration and the criteria; and
ii. an operating module to process the selected data.

16. The system according to claim 15, wherein the selecting module enables selection of at least one corresponding data part of the at least one related data set upon selection of a data part in the data set.

17. The system according to claim 15, wherein the operating module further comprises an archiving module to archive the selected data in a second database.

18. The system according to claim 17, wherein the processing module further comprises a de-archiving module to de-archive the archived data from the second database

19. The system according to claim 18, wherein each of the plurality of data sets is a table comprising a plurality of records.

20. The system according to claim 19, wherein the de-archiving module comprises:
a. a batch processing module, the batch processing module de-archiving a plurality of records from the archived data at an instance; and
b. a transaction processing module, the transaction processing module de-archiving a record from the archived data at an instance

21. The system according to claim 17, wherein the second database is part of the database.

22. The system according to claim 15, wherein the operating module further comprises a purging module to purge the selected data in the database.

23. A method for managing at least one database, the at least one database comprising a plurality of data sets, each data set comprising a plurality of data parts, at least one of the plurality of data sets being related to at least one of the plurality of the rest of the data sets, the method comprising the steps of:
a. creating at least one configuration representing a relationship between at least one data set and at least one related data set;
b. defining at least one criterion to be applied on the configuration, the at least one criterion being applied on the at least one configuration to identify data from the at least one data set and the at least one related dataset;
c. selecting data from the database using the at least one configuration and the at least one criterion; and
d. processing the selected data.

24. The method according to claim 23, wherein the step of creating the at least one configuration comprises the step of selecting a predefined number of datasets from the at least one database.

25. The method according to claim 23, wherein the database is part of an online transaction processing system.

26. The method according to claim 23, wherein the step of creating a configuration comprises the steps of:
a. identifying a data set; and
b. linking the data set to the at least one related data set.

27. The method according to claim 23, wherein the step of selecting data using the configuration comprises the step of selecting at least one corresponding data part of the at least one related data set upon selection of a data part in the data set.

28. The method according to claim 23, wherein the step of processing the selected data comprises the step of purging the selected data from the database.

29. The method according to claim 23, wherein the step of processing the selected data comprises the step of archiving the selected data in a second database.

30. The method according to claim 29, wherein the step of archiving the selected data further comprises the step of archiving the selected data on the basis of a pre-defined policy.

31. The method according to claim 29, further comprising the step of de-archiving the archived data from the second database.

32. The method according to claim 23, wherein each of the plurality of data sets is a table comprising a plurality of records.

33. The method according to claim 32, further comprising the step of processing a plurality of records from the selected data at an instance.

34. The method according to claim 32, further comprising the step of processing a record from the selected data at an instance.

35. The method according to claim 23, further comprising the step of scheduling the processing of the selected data.

36. A computer program product for managing a database, the database comprising a plurality of data sets, each data set comprising a plurality of data parts, at least one of the plurality of data sets being related to at least one of the plurality of the rest of the data sets, the computer program product comprising a computer readable medium comprising:
a. program instruction means for creating at least one configuration, the at least one configuration representing a relationship between at least one data set and at least one related data set;
b. program instruction means for defining at least one criterion to be applied on the configuration, the at least one criterion being applied on the at least one configuration to identify data from the at least one data set and the at least one related dataset;
c. program instruction means for selecting data from the database using the configuration and the at least one criterion; and
d. program instruction means for processing the selected data.
